(19) United States
(12) Patent Application Publication
(10) Pub. No.: US 2009/0273852 A1
(43) Pub. Date: Nov. 5, 2009

(54) IMAGING DEVICE WITH MICRO-SCALE OPTICAL STRUCTURES

(75) Inventors: Yuan-Hung WANG, Gueishan Township (TW); Daniel Liang, Gueishan Township (TW); Yih-Far Chen, Gueishan Township (TW); Cheng-Chung Kuan, Gueishan Township (TW); Chun-Lang Liao, Gueishan Township (TW)

Correspondence Address: BIRCH STEWART KOLASCH & BIRCH, PO BOX 747, FALLS CHURCH, VA, 22040-0747, US

(73) Assignee: U-Tech Media Co., Ltd., Gueishan Township (TW)

(21) Appl. No.: 12/434,267

(22) Filed: May 1, 2009

Related U.S. Application Data
(60) Provisional application No. 61/049,870, filed on May 2, 2008.

(51) Int. Cl. G02B 5/10

(52) U.S. Cl. 359/864

(57) ABSTRACT

An imaging device with micro-scale optical structures comprises a plurality of display units, where each display unit comprises a plurality of micro-scale optical structures, and each micro-scale optical structure comprises a convex part, a planar part, and base part. The convex part is positioned on the base part and has an arc surface, where the arc surface comprises a left side arc face and a right side arc face for reflecting oblique incident lights from the left or the right to form a reflected light toward the front. And different arrangements of micro-scale optical structures are used for reflecting left side and right side incident lights to display different characters or images.

### BACKGROUND OF THE INVENTION

1. Field of the Invention

The present invention relates to an imaging device, and more especially, to an imaging device with micro-scale optical structures.

2. The Prior Arts

The technology of display devices is fairly well-developed and display devices are quite well-equipped, especially for liquid crystal displays (LCDs). LCDs with characteristics of compact design and low power consumption are widely used as primary devices for displaying images or characters in domains of information application and house appliances.

However, due to the fact that LCDs are technology-intensive products with advanced integration of optics, mechanisms, and electrical technology, at the same time a higher standard in physical environment is required, LCDs are less proper to be used as non-dynamic outdoor displays in such applications with only static characters or images to be shown. Moreover, harsh weather conditions should be fight against, thus general painting-style planar billboards or tri-vision bulletins with triangular prisms are not as advisable in the trend of energy conservation for not only the fact that electricity is required to drive motors of the triangular prisms of the tri-vision bulletins but also the structure of such bulletins is complicated notwithstanding three images can be shown on one bulletin.

Therefore, an imaging device being able to display different characters or images with a simple structure is needed so that no extra energy is required and at the same time with high tolerance for weather conditions as well as high reliability to overcome the shortcomings of the existing art.

### SUMMARY OF THE INVENTION

The objective of the present invention is to provide an imaging device with micro-scale optical structures comprising a plurality of display units, each display unit comprises a plurality of micro-scale optical structures, and each micro-scale optical structure has a convex part, a planar part, and a base part. The convex part is positioned on the base part and has an arc surface where the arc surface comprises a left side arc surface and a right side arc surface reflecting an oblique incident light from the left or the right to form a reflected light gathered toward the front. And different arrangements of micro-scale optical structures are used for reflecting left side or right side incident lights to display different characters or images.

By the imaging device with micro-scale optical structures according to the present invention, different characters or images are shown by irradiation of passive light sources or active light resources emitted by the observers. The device is a display device with light source directivity, and can be applied to public announcing, advertising, propagandizing, signaling, guiding, warning, and the like.

The present invention will be described and illustrated in detail in the following with specific embodiments. It shall be understood that the embodiments disclosed herein are for illustrating the present invention rather than limiting the scope of the present disclosure. Those skilled in the art will recognize certain modifications, variations, permutations, additions and sub-combinations thereof. It is therefore intended that the following appended claims and claims hereafter introduced are interpreted to include all such modifications, permutations, additions and sub-combinations as are within the spirit and scope of the present invention.

### BRIEF DESCRIPTION OF THE DRAWINGS

FIG. 1 is a schematic diagram showing the imaging device with micro-scale optical structures according to the present invention;

FIG. 2 is a cross-sectional diagram of the micro-scale optical structures according to the first embodiment of the present invention;

FIG. 3 is an explanatory diagram showing the reflection effect of the micro-scale optical structures according to the first embodiment of the present invention;

FIG. 4 is a schematic diagram showing the reflection effect of the micro-scale optical structures according to the embodiment of the present invention;

FIG. 5A is an example showing characters reflected by the micro-scale optical structures based on an incident light from the left according to the present invention;

FIG. 5B is an example showing characters reflected by the micro-scale optical structures based on an incident light from the right according to the present invention;

FIG. 6A is another example showing images reflected by the micro-scale optical structures based on an incident light from the left according to the present invention;

FIG. 6B is another example showing images reflected by the micro-scale optical structures based on an incident light from the right according to the present invention;

FIG. 7 is a cross-sectional diagram of the micro-scale optical structures according to the second embodiment of the present invention;

FIG. 8 is an explanatory diagram showing the reflection effect of the micro-scale optical structures according to the second embodiment of the present invention;

FIG. 9 is an explanatory diagram showing the reflection effect of the micro-scale optical structures according to the third embodiment of the present invention; and

FIG. 10 is an explanatory diagram showing the reflection effect of the micro-scale optical structures according to the fourth embodiment of the present invention.

### DETAILED DESCRIPTION OF THE PREFERRED EMBODIMENT

Detailed description is given as following in accompanying with drawings and referring numbers for explanation to the embodiments of the present invention, so that the present invention can be realized by those skilled in the art.

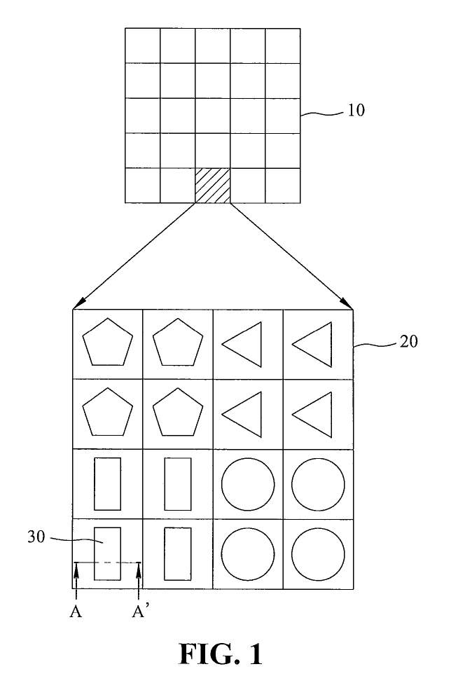

Refer to FIG. 1, an explanatory diagram showing the imaging device with micro-scale optical structures according to the present invention. As shown in FIG. 1, the imaging device 10 according to present invention has a reflective surface, and comprises a plurality of display units 20 arranged on a display surface, each display unit 20 comprises a plurality of micro-scale optical structures 30, whereas micro-scale optical structures 30 can be semi-circular, circular, trigonal, tetragonal, rectangular, or polygonal.

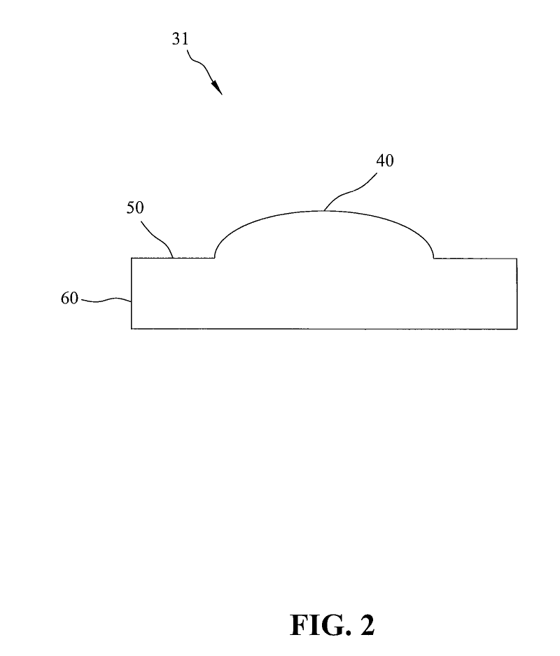

Refer to FIG. 2, a cross-sectional diagram of the micro-scale optical structures according to the first embodiment of the present invention. FIG. 2 is a cross-sectional diagram of the micro-scale optical structures in FIG. 1 along the secant line AA′. Each of the micro-scale optical structure 31 comprises a convex part 40, a planar part 50, and a base part 60. The convex part 40 is positioned on the base part 60, and the convex part 40 has an arc surface. From the structure of the micro-scale optical structure 31 shown in FIG. 1 and FIG. 2, due to the fact that the arc surface of the convex part 40 of the micro-scale optical structure 31 causes different reflection effects based on incident light from different directions, moreover, the imaging device 10 with micro-scale optical structures 31 in diverse shapes can enhance reflection effects, different characters or images can be shown to the observers at the front.

The size of each of the micro-scale optical structure 31 according to the present invention can be ranging from 0.2 μm to 1000 μm, preferably ranging from 0.5 μm to 500 μm, based on the optical effect and tactile needed. At the same time, different display effects can be achieved by permutation and combination of the micro-scale optical structures 31 along with the reflection characteristic of directional light source.

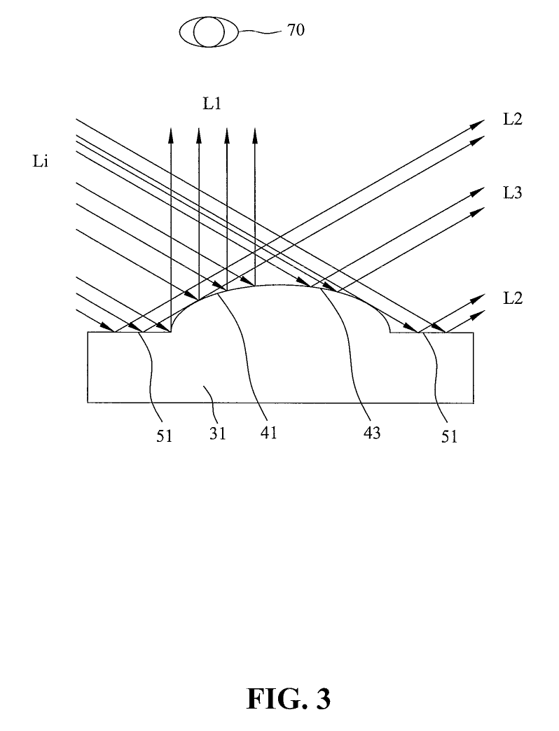

Refer to FIG. 3, an explanatory diagram showing the reflection effect of the micro-scale optical structures according to the first embodiment of the present invention. As shown in FIG. 3, the arc surface of the convex part comprises a left side arc face 41 and a right side arc face 43, and the planar part has a smooth face 51. An oblique incident light Li from the left is reflected by the micro-scale optical structures 30 forming a first reflected light L1, a second reflected light L2, and a third reflected light L3. The first reflected light L1 is the reflected light of the left side arc face 41 of the convex part 40 of the micro-scale optical structure 31, whereas the second reflected light L2 is the reflected light of smooth face 51 of the micro-scale optical structure 31, and the third reflected light L3 is the reflected light of the right side arc face 43 of the convex part 40 of the micro-scale optical structure 31.

According to the fundamental principle of optical reflection, the first reflected light L1 reflected by the left side arc face 41 travels toward the observer 70, the second reflected light L2 reflected by the smooth face 51 travels toward a right direction relative to the front side of the display surface, and the third reflected light L3 reflected by the right side arc face 43 travels toward a more right direction relative to the front side of the display surface, thus the observer 70 primarily sees the first reflected light L1. Likewise, for the oblique incident light from the right, a fourth reflected light reflected by the right side arc face 43 can be seen by the observer, whereas for the oblique incident light from the right, a fifth reflected light and a six reflected light reflected by the left side arc face 41 and the smooth face 51, respectively, cannot be seen. The oblique incident light from the right, the fourth reflected light, the fifth reflected light, and the sixth reflected light are not shown in the figure. Therefore, the reflected light in different characters and images based on the incident light from different directions can be seen by the observer.

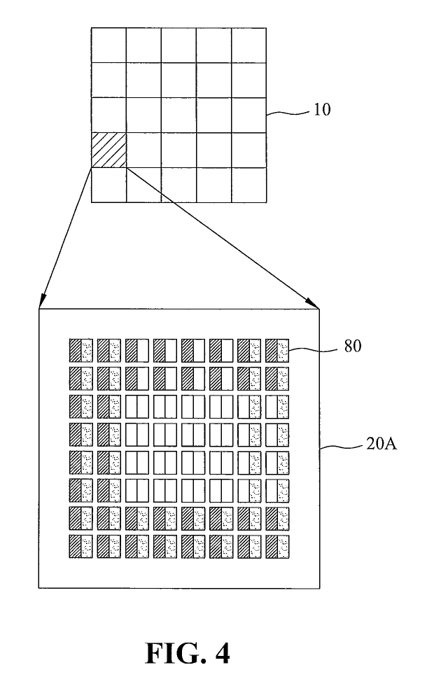

Refer to FIG. 4, an explanatory diagram showing the reflection effect of the micro-scale optical structures according to the embodiment of the present invention. As shown in FIG. 4, for clarification purposes, one of the display units of the imaging device 10, display unit 20A, is divided into a plurality of micro-scale display units 80. The display units 80 are represented by rectangles for simplicity. The left-half side of each micro-scale display unit 80 is represented as a slashed region or a blank region, whereas the right-half side of each micro-scale display unit 80 is represented as a dotted region or a blank region, for differentiating reflection effects of the incident light from the left and the incident light from the right. The slashed region represents the reflected light of the incident light from the left, the dotted region represents the reflected light of the incident light from the right, and the blank region represents a smooth surface.

It is to be noted that the left-half sides and the right-half sides of the micro-scale display units 80 can be a combination of a plurality of the micro-scale optical structures 30 in diverse shapes, by which a reflected light shown with different content is formed ∘

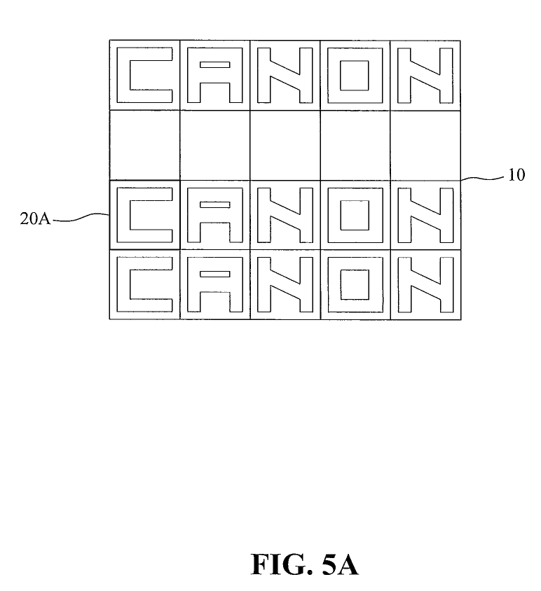

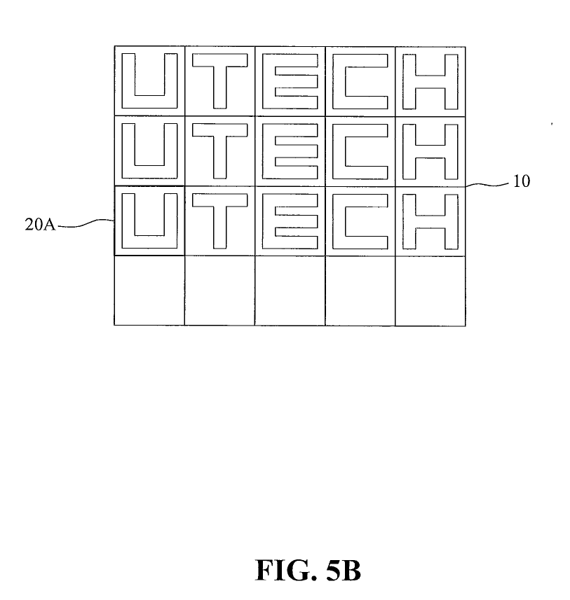

Refer to FIG. 5A and FIG. 5B for showing the characters reflected by the micro-scale optical structures based on the direction of the incident light according to the present invention. As shown in FIG. 5A, the display unit 20A of the imaging device 10 shows a letter, “C”, when the incident light is from the left, whereas in FIG. 5B, the display unit 20A of the imaging device 10 shows a letter, “U”, when the incident light is from the right. Furthermore, according to the aforesaid description, different sequential characters can be shown by arranging the micro-scale optical structures 30 with different shapes in individual display unit 20, as the sequential characters “CANNON” and “UTECH” shown in FIG. 5A and FIG. 5B, respectively. Therefore, by controlling the direction of incident light, diverse characters can be shown on a single imaging device which is applied to public announcing, advertising, propagandizing, signaling, guiding, warning, and the like.

It is to be noted that the sequential characters shown in FIG. 5A and FIG. 5B are an example for explaining a feature of the present invention, not to limit the scope of the present invention. The micro-scale optical structures can be properly arranged on the imaging device according to the present invention for displaying.

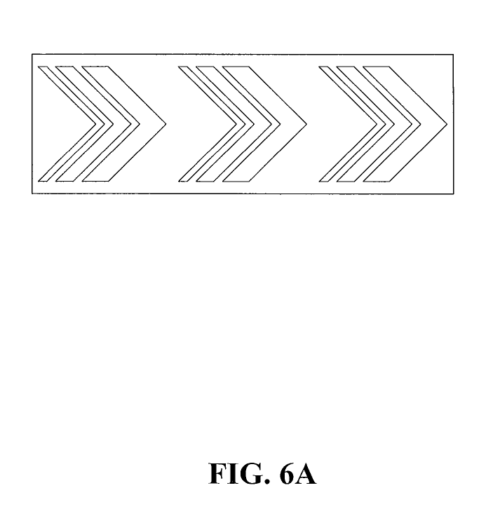

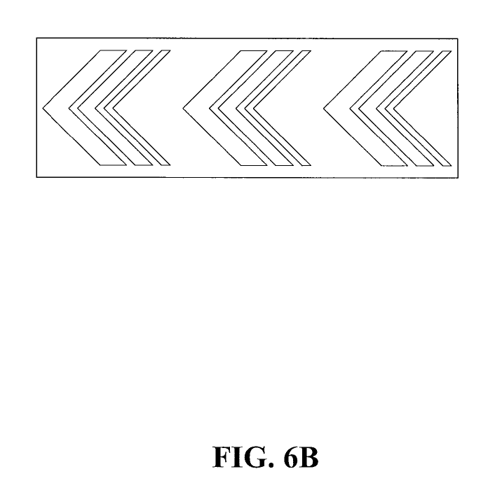

Refer to FIG. 6A and FIG. 6B for another example showing the images reflected by the micro-scale optical structures based on the direction of the incident light according to the present invention. According to the feature of the present invention, another reflection effect of the micro-scale optical structures is shown in FIG. 6A and FIG. 6B. An image of a right turn sign and an image of a left turn sign are shown in FIG. 6A and FIG. 6B, respectively, and can be used for pointing directions or indicating destinations.

Moreover, it can be an active incident light emitted by observers such as head lights of a car turned on by the driver at night that irradiates the imaging device according to the present invention, so that the observer on the left side of the imaging device can only see the characters or images designed to be seen on the left side of the imaging device but not the characters or images designed to be seen on the right side of the imaging device. Likewise, the observer on the right side of the imaging device can only see the characters or images designed to be seen on the right side of the imaging device but not the characters or images designed to be seen on the left side of the imaging device.

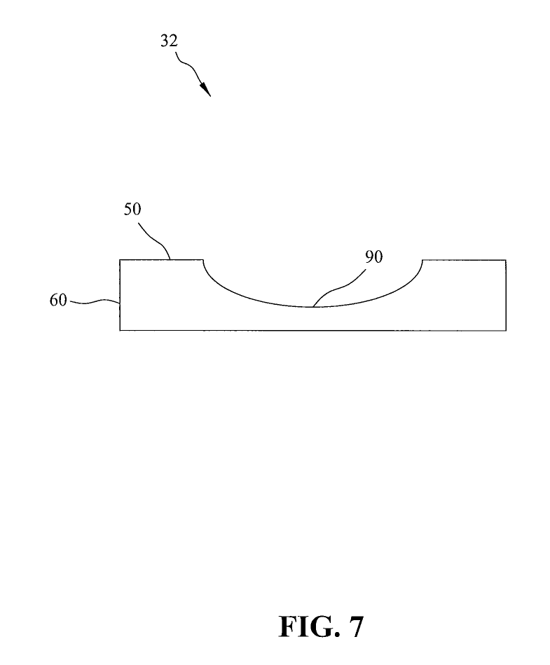

The aforesaid convex part 40 of the micro-scale optical structures 31 can be a concave part 90. As shown in FIG. 7, a cross-sectional diagram of the micro-scale optical structures according to the second embodiment of the present invention. As shown in FIG. 7, each of the micro-scale optical structure 32 comprises a concave part 90, a planar part 50, and a base part 60. The concave part 90 is positioned in the base part 60, and the concave part 90 has an arc surface. Micro-scale optical structures 32 can be semi-circular, circular, trigonal, tetragonal, rectangular, or polygonal. From the structure of the micro-scale optical structure 32 shown in FIG. 1 and FIG. 7, due to the fact that the arc surface of the concave part 90 of the micro-scale optical structure 32 causes different reflection effects based on incident light from different directions, moreover, the imaging device 10 with micro-scale optical structures 32 in diverse shapes can enhance reflection effects, different characters or images can be shown to the observers at the front.

The size of each of the micro-scale optical structure 32 according to the present invention can be ranging from 0.2 μm to 1000 μm, preferably ranging from 0.5 μm to 500 μm, based on the optical effect and tactile needed. At the same time, different display effects can be achieved by permutation and combination of the micro-scale optical structures 32 along with the reflection characteristic of directional light source.

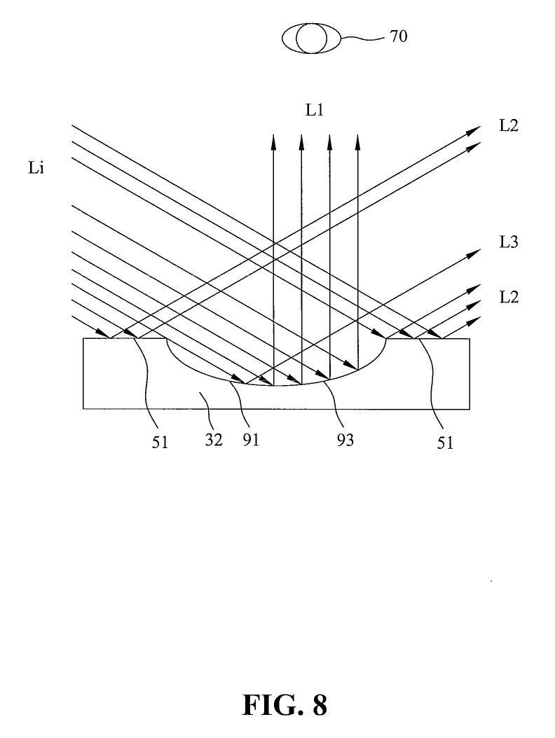

Refer to FIG. 8, an explanatory diagram showing the reflection effect of the micro-scale optical structures according to the second embodiment of the present invention. As shown in FIG. 8, the arc surface of the concave part comprises a left side arc face 91 and a right side arc face 93, and the planar part has a smooth face 51. An oblique incident light Li from the left is reflected by the micro-scale optical structures 32 forming a first reflected light L1, a second reflected light L2, and a third reflected light L3. The first reflected light L1 is the reflected light of the right side arc face 93 of the concave part 90 of the micro-scale optical structure 32, whereas the second reflected light L2 is the reflected light of smooth face 51 of the micro-scale optical structure 32, and the third reflected light L3 is the reflected light of the left side arc face 91 of the concave part 90 of the micro-scale optical structure 32.

According to the fundamental principle of optical reflection, the first reflected light L1 reflected by the right side arc face 93 travels toward the observer 70, the second reflected light L2 reflected by the smooth face 51 travels toward a right direction relative to the front side of the display surface, and the third reflected light L3 reflected by the left side arc face 91 travels toward a more right direction relative to the front side of the display surface, thus the observer 70 primarily sees the first reflected light L1. Likewise, for the oblique incident light from the right, a fourth reflected light reflected by the left side arc face 91 can be seen by the observer, whereas for the oblique incident light from the right, a fifth reflected light and a six reflected light reflected by the right side arc face 93 and the smooth face 51, respectively, cannot be seen. The oblique incident light from the right, the fourth reflected light, the fifth reflected light, and the sixth reflected light are not shown in the figure. Therefore, the reflected light in different characters and images based on the incident light from different directions can be seen by the observer.

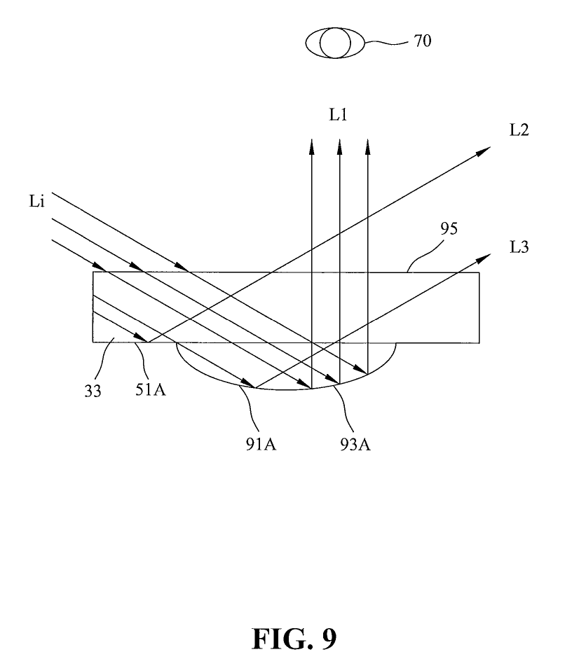

Refer to FIG. 9, an explanatory diagram showing the reflection effect of the micro-scale optical structures according to the third embodiment of the present invention. As shown in FIG. 9, each of the micro-scale optical structures 33 is formed with light transmissive materials, and each of the micro-scale optical structures 33 has an upper surface and a lower surface. The upper surface is a light transmissive surface 95, whereas the lower surface has a light reflectivity and comprises a smooth face 51A and an arc-shaped left side convex arc face 91A and right side convex arc face 93A. An oblique incident light Li from the left passes through the light transmissive surface 95 of the micro-scale optical structure 33, and then transmits to the right side convex arc face 93A, the smooth face 51A, and the left side convex arc face 91A. Next, after being reflected by the right side convex arc face 93A, the smooth face 51A, and the left side convex arc face 91A and transmitted by the light transmissive surface 95, the first reflected light L1, the second reflected light L2, and the third reflected light L3 are formed, respectively. The first reflected light L1 primarily travels toward the observer 70 whereas the second reflected light L2 and the third reflected light L3 primarily deviate from the observer and travels toward the right side. Therefore the observer 70 primarily sees the first reflected light L1.

Likewise, for an oblique incident light from the right, the light transmitted will be reflected by the left side convex arc face 91A and primarily travels toward the observer 70, whereas the light reflected by the smooth face 51A and the right side convex arc face 93A will travel toward the left side, so that the observer 70 primarily sees the light reflected by the left side convex arc face 91A.

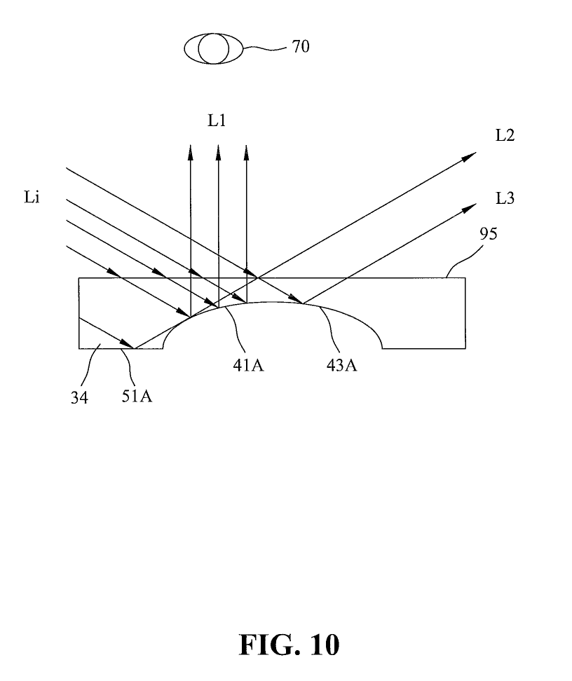

Refer to FIG. 10, an explanatory diagram showing the reflection effect of the micro-scale optical structures according to the fourth embodiment of the present invention. As shown in FIG. 10, each of the micro-scale optical structures 34 is formed with light transmissive materials, and each of the micro-scale optical structures 34 has an upper surface and a lower surface. The upper surface is a light transmissive surface 95, whereas the lower surface has a light reflectivity and comprises a smooth face 51A and an arc-shaped left side concave arc face 41A and right side concave arc face 43A. An oblique incident light Li from the left passes through the light transmissive surface 95 of the micro-scale optical structure 34, and then transmits to the left side concave arc face 41A, the smooth face 51A, and the right side concave arc face 43A. Next, after being reflected by the left side concave arc face 41A, the smooth face 51A, and the right side concave arc face 43A and transmitted by the light transmissive surface 95, the first reflected light L1, the second reflected light L2, and the third reflected light L3 are formed, respectively. The first reflected light L1 primarily travels toward the observer 70 whereas the second reflected light L2 and the third reflected light L3 primarily deviate from the observer and travels toward the right side. Therefore the observer 70 primarily sees the first reflected light L1.

Likewise, for an oblique incident light from the right, the light transmitted will be reflected by the right side concave arc face 43A and primarily travels toward the observer 70, whereas the light reflected by the smooth face 51A and the left side concave arc face 41A will travel toward the left side, so that the observer 70 primarily sees the light reflected by the right side concave arc face 43A.

It is to be noted that the incident light from the left and the incident light form the right are used for illustrating the features of the convex part or the concave part of the micro-scale optical structures reflecting the incident light from the left and the incident light form the right for displaying symbols, characters, patterns or images, and with no intention of limiting the direction of the incident light. For instance, for an upper oblique incident light and a lower oblique incident light, the micro-scale optical structures according to the present invention are oriented with one portion of the arc face facing the upper oblique incident light and the other portion of the arc face facing the lower oblique incident light. Thus, the micro-scale optical structures according to the present invention can be applied to incident light with any direction.

What is claimed is:

1. An imaging device with micro-scale optical structures, comprising a plurality of display units arranged on a display surface,
wherein each display unit comprises a plurality of micro-scale optical structures, each micro-scale optical structure comprises a convex part, a planar part, and a base part, the convex part is positioned on the base part and has an arc surface, the planar part has a smooth face, the base part is flat, and the arc surface of the convex part comprises a left side arc face and a right side arc face;
wherein the left side arc face is used for reflecting an oblique incident light from the left to form a first reflected light toward a front side of the display surface, the smooth face of the planar part is used for reflecting an oblique incident light from the left to form a second reflected light toward a right direction relative to the front side of the display surface, and the right side arc face is used for reflecting an oblique incident light from the left to form a third reflected light toward a more right direction relative to the front side of the display surface, so that the first reflected light can be seen by a observer at the front but not the second reflected light and the third reflected light, and a fourth reflected light formed through reflection of an oblique incident light from the right by the right side arc face can be seen by the observer but not the fifth reflected light and the sixth reflected light formed through reflection of the oblique incident light from the right by the left side arc face and the smooth face, respectively.

2. The imaging device with micro-scale optical structures according to claim 1, wherein the micro-scale optical structure has at least one shape of semi-circular, circular, trigonal, and tetragonal.

3. The imaging device with micro-scale optical structures according to claim 1, wherein the micro-scale optical structure has a polygon shape.

4. The imaging device with micro-scale optical structures according to claim 1, wherein the micro-scale optical structure has a size of 0.5 μm to 500 μm.

5. An imaging device with micro-scale optical structures, comprising a plurality of display units arranged on a display surface,
wherein each display unit comprises a plurality of micro-scale optical structures, each micro-scale optical structure comprises a concave part, a planar part, and a base part, the concave part is positioned in the base part and has an arc surface, the planar part has a smooth face, the base part is flat, and the arc surface of the concave part comprises a right side arc face and a left side arc face;
wherein the right side arc face is used for reflecting an oblique incident light from the left to form a first reflected light toward a front side of the display surface, the smooth face of the planar part is used for reflecting an oblique incident light from the left to form a second reflected light toward a right direction relative to the front side of the display surface, and the left side arc face is used for reflecting an oblique incident light from the left to form a third reflected light toward a more right direction relative to the front side of the display surface, so that the first reflected light can be seen by a observer at the front but not the second reflected light and the third reflected light, and a fourth reflected light formed through reflection of an oblique incident light from the right by the left side arc face can be seen by the observer but not the fifth reflected light and the sixth reflected light formed through reflection of the oblique incident light from the right by the right side arc face and the smooth face, respectively.

6. The imaging device with micro-scale optical structures according to claim 5, wherein the micro-scale optical structure has at least one shape of semi-circular, circular, trigonal, and tetragonal.

7. The imaging device with micro-scale optical structures according to claim 5, wherein the micro-scale optical structure has a polygon shape.

8. The imaging device with micro-scale optical structures according to claim 5, wherein the micro-scale optical structure has a size of 0.5 μm to 500 μm.

9. An imaging device with micro-scale optical structures, comprising a plurality of display units arranged on a display surface,
wherein each display unit comprises a plurality of micro-scale optical structures, each micro-scale optical structure comprises an upper surface and a lower surface, wherein the upper surface is a light transmissive surface, and the lower surface has a light reflectivity and comprises a smooth face and an arc-shaped left side convex arc face and right side convex arc face;
wherein an oblique incident light from the left passes through the light transmissive surface of the micro-scale optical structure, and then transmits to the right side convex arc face, the smooth face, and the left side convex arc face, after being reflected by the right side convex arc face, the smooth face, and the left side convex arc face and transmitted by the light transmissive surface, a first reflected light, a second reflected light, and a third reflected light are formed, respectively; and
wherein the first reflected light primarily travels toward the observer at the front of the display units whereas the second reflected light and the third reflected light primarily deviate from the observer and travels toward the right side, therefore the observer primarily sees the first reflected light.

10. The imaging device with micro-scale optical structures according to claim 9, wherein the micro-scale optical structure has at least one shape of semi-circular, circular, trigonal, and tetragonal.

11. The imaging device with micro-scale optical structures according to claim 9, wherein the micro-scale optical structure has a polygon shape.

12. The imaging device with micro-scale optical structures according to claim 9, wherein the micro-scale optical structure has a size of 0.5 μm to 500 μm.

13. An imaging device with micro-scale optical structures, comprising a plurality of display units arranged on a display surface,
wherein each display unit comprises a plurality of micro-scale optical structures, each micro-scale optical structure comprises an upper surface and a lower surface, wherein the upper surface is a light transmissive surface, and the lower surface has a light reflectivity and comprises a smooth face and an arc-shaped left side concave arc face and right side concave arc face;
wherein an oblique incident light from the left passes through the light transmissive surface of the micro-scale optical structure, and then transmits to the left side concave arc face, the smooth face, and the right side concave arc face, after being reflected by the left side concave arc face, the smooth face, and the right side concave arc face and transmitted by the light transmissive surface, a first reflected light, a second reflected light, and a third reflected light are formed, respectively; and
wherein the first reflected light primarily travels toward the observer at the front of the display units whereas the second reflected light and the third reflected light primarily deviate from the observer and travels toward the right side, therefore the observer primarily sees the first reflected light.

14. The imaging device with micro-scale optical structures according to claim 13, wherein the micro-scale optical structure has at least one shape of semi-circular, circular, trigonal, and tetragonal.

15. The imaging device with micro-scale optical structures according to claim 13, wherein the micro-scale optical structure has a polygon shape.

16. The imaging device with micro-scale optical structures according to claim 13, wherein the micro-scale optical structure has a size of 0.5 μm to 500 μm.
